(19) United States
(12) Patent Application Publication
(10) Pub. No.: US 2025/0323793 A1
(43) Pub. Date: Oct. 16, 2025

(54) LOG GENERATION DEVICE, SENSOR MODULE, LOG GENERATION MODULE, AND ELECTRONIC CONTROL SYSTEM

(71) Applicant: DENSO CORPORATION, Kariya-city (JP)

(72) Inventors: Yosuke NIIMI, Kariya-city (JP); Kazuki KASHIWABARA, Kariya-city (JP)

(21) Appl. No.: 19/170,110

(22) Filed: Apr. 4, 2025

(30) Foreign Application Priority Data
Apr. 10, 2024 (JP) 2024-063142

(51) Int. Cl. H04L 9/32; H04L 9/08

(52) U.S. Cl. CPC H04L 9/3236; H04L 9/0825; H04L 9/3247

(57) ABSTRACT

A log generation device includes a sensor module and a log generation module. The sensor module is configured to generate event data indicating an event when detecting the event; generate first verification data for verifying authenticity of the event data; and generate a security log including the event data and the first verification data. The log generation module is configured to acquire the security log generated by the sensor module; generate a second verification data using the event data included in the security log; and verify identity of the first verification data and the second verification data. The log generation device is further configured to transmit the event data when the first verification data and the second verification data are identical.

### CROSS REFERENCE TO RELATED APPLICATION

This application is based on Japanese Patent Application No. 2024-063142 filed on Apr. 10, 2024, the disclosure of which is incorporated herein by reference.

### TECHNICAL FIELD

The present disclosure relates to a log generation device primarily mounted on a movable body such as an automobile, a sensor module and a log generation module included in the log generation device, an electronic control system comprising the log generation device and a log collection device that collects a log generated by the log generation device, and a method and a program executed by these devices.

### BACKGROUND

A related art describes a method in which a hash value is calculated using an encryption key and a hash function for transmission target data sent from one communication device to another communication device within an electronic control system. A data frame containing the transmission target data and the calculated hash value is generated. The receiving communication device, upon receiving the data frame, verifies the hash value within the data frame to confirm the correctness of the received data.

### SUMMARY

A log generation device includes a sensor module and a log generation module. The sensor module is configured to generate event data indicating an event when detecting the event; generate first verification data for verifying authenticity of the event data; and generate a security log including the event data and the first verification data. The log generation module is configured to acquire the security log generated by the sensor module; generate a second verification data using the event data included in the security log; and verify identity of the first verification data and the second verification data. The log generation device is further configured to transmit the event data when the first verification data and the second verification data are identical.

### BRIEF DESCRIPTION OF DRAWINGS

Objects, features and advantages of the present disclosure will become more apparent from the following detailed description made with reference to the accompanying drawings. In the drawings:

FIG. 1 is an explanatory diagram illustrating the arrangement of the log generation device in each embodiment and a relationship with related devices;

FIG. 2 is a block diagram showing an example configuration of the electronic control system in each embodiment;

FIG. 3 is a block diagram showing an example configuration of the log generation device in a first embodiment;

FIG. 4 is a diagram explaining a log generated by the sensor module and the verification of the log in the first embodiment;

FIG. 5 is a diagram explaining the log generated by the log generation module in the first embodiment;

FIG. 6 is a diagram explaining the verification data in the first embodiment;

FIG. 7 is a diagram explaining the verification data in the first embodiment;

FIG. 8 is a flowchart explaining the operation of the log generation device in the first embodiment;

FIG. 9 is a flowchart explaining the operation of the log generation device in the first embodiment;

FIG. 10 is a block diagram showing an example configuration of the log collection device in the first embodiment;

FIG. 11 is a flowchart explaining the operation of the log collection device in the first embodiment;

FIG. 12 is a block diagram showing an example configuration of the log generation device in a second embodiment;

FIG. 13 is a diagram explaining a log generated by the log generation device in the second embodiment;

FIG. 14 is a flowchart explaining the operation of the log generation device in the second embodiment;

FIG. 15 is a block diagram showing an example configuration of the log generation device in a third embodiment;

FIG. 16 is a diagram explaining a log generated by the log generation device in the third embodiment;

FIG. 17 is a flowchart explaining the operation of the log generation device in the third embodiment;

FIG. 18 is a block diagram showing an example configuration of the log generation device in a fourth embodiment;

FIG. 19 is a flowchart explaining the operation of the log collection device in a first example of modification of each embodiment; and

FIG. 20 is a diagram explaining a log generated by the log generation device in a second example of modification of each embodiment.

### DETAILED DESCRIPTION

In recent years, technologies such as V2X, including vehicle-to-vehicle and vehicle-to-infrastructure communications, as well as driving assistance and autonomous driving control, have garnered attention. Consequently, a vehicle is now equipped with a communication function, advancing the so-called connected vehicle trend. As a result, the likelihood of a vehicle being subjected to a cyber-attack, such as unauthorized access, may have increased. When a vehicle is subjected to a cyber-attack, the data transmitted and received by the vehicle may be tampered with. Therefore, it may be necessary to verify the integrity of the data transmitted and received within the vehicle, as well as the data exchanged between the vehicle and an external entity.

Here, the inventors of the present disclosure have identified the following difficulties through detailed investigation. The data transmitted and received by a vehicle includes a log that records abnormality occurring in the vehicle. Such log is generated when a security sensor module mounted on an vehicle onboard device detects an abnormality and is transmitted to another onboard device via another module mounted on the same device as the security sensor. However, if the log is corrupted or tampered with between the time the log is generated by the security sensor and the time the log is transmitted to another communication device, incorrect information will be sent to the other onboard device. Additionally, a log, which records such abnormality, is typically transmitted to an external device of the vehicle and used for analyzing cyber-attacks or vulnerability of an onboard device. If the analysis is based on a corrupted or tampered log, the accuracy of the analysis may decrease.

The present disclosure provides a log generation device and the like that can verify the integrity of a log generated by a security sensor.

According to one aspect of the present disclosure, a log generation device including a sensor module, and a log generation module is provided. The sensor module includes: an event data generation unit configured to generate event data indicating the event when detecting an event; a first verification data generation unit configured to generate first verification data for verifying authenticity of the event data; and a log generation unit configured to generate a security log including the event data and the first verification data. The log generation module includes: a log acquisition unit configured to acquire the security log generated by the sensor module; a second verification data generation unit configured to generate second verification data using the event data included in the security log; and a verification unit configured to verify identity of the first verification data and the second verification data; and the log generation device further comprises a transmission unit configured to transmit the event data when the first verification data and the second verification data are identical.

According to these configurations, the log generation device and the like of the present disclosure can be configured to transmit only logs whose integrity has been verified to another electronic control device.

Embodiments of the present disclosure will be described with reference to the drawings.

The effects described in the embodiments are the effects when the configurations of the embodiments as examples of the present disclosure are employed, and are not necessarily the effects of the present disclosure.

When there are multiple embodiments, the configurations disclosed in each embodiment are not limited to each embodiment alone, and can be combined across embodiments. For example, the configuration disclosed in one embodiment may be combined with another embodiment. Additionally, the configurations disclosed in each of the multiple embodiments may be collected and combined.

### 1. BASIC CONFIGURATION OF EACH EMBODIMENT

### (1) Arrangement of Log Generation Device and Relationship with Related Devices

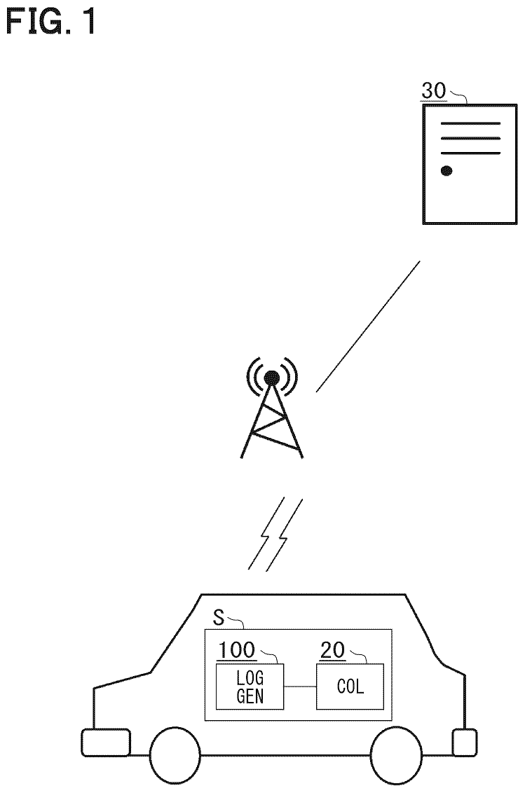

FIG. 1 is a diagram explaining the arrangement of the log generation device in each embodiment and its relationship with related devices. FIG. 1 illustrates and explains only the log generation device 100 of the first embodiment, but the log generation devices 200, 300, and 400 of a second to fourth embodiments are also arranged similarly to the log generation device 100. The log generation devices 100, 200, 300, and 400 will be collectively referred to as the log generation device 100 or the like.

As shown in FIG. 1, the log generation device 100 or the like, together with the log collection device 20, constitutes an electronic control unit of the electronic control system S. Both the log generation device 100 and the log collection device 20 are “mounted” on a vehicle, which is a “movable body.” The electronic control units in each embodiment may be physically independent electronic control units or virtualized electronic control units realized using virtualization technology, and are referred to as ECUs (Electronic Control Units). The configurations of the log generation device 100 and the log collection device 20 will be described in each embodiment.

Here, a “movable body” refers to a movable object, and the moving speed is arbitrary. This includes cases where the movable body is stationary. Examples of a movable body include an automobile, a motorcycle, a bicycle, a pedestrian, a ship, aircraft, and an object mounted on it, but are not limited to these. The term “mounted” means not only being directly fixed to the movable body but also includes cases where it is not fixed to the movable body but moves together with the movable body. For example, it includes cases where a person riding on the movable body possesses it, or it is mounted on cargo placed on the movable body.

The external device 30 is any device provided outside the vehicle, and an example is a Security Operations Center (SOC) that detects and analyzes cyber-attacks.

In FIG. 1, the electronic control system S and the external device 30 are connected via a communication network using, for example, wireless communication methods such as IEEE 802.11 (Wi-Fi (registered trademark)), IEEE 802.16 (WiMAX (registered trademark)), W-CDMA (Wideband Code Division Multiple Access), HSPA (High Speed Packet Access), LTE (Long Term Evolution), LTE-A (Long Term Evolution Advanced), 4G, 5G or the like. Alternatively, DSRC (Dedicated Short Range Communication) can be used. When the vehicle is parked in a parking lot or housed in a repair shop, a wired communication method can be used instead of a wireless communication method. For example, LAN (Local Area Network), the Internet, or fixed telephone lines can be used.

Additionally, a line combining wireless and wired communication methods may be used. For example, the electronic control system S and the base station device in the cellular system may be connected by a wireless communication method such as 4G, and the base station device and the external device 30 may be connected by a wired communication method such as the core line of a communication carrier or the Internet. A gateway device may be provided at the junction between the core line and the Internet.

### (2) Configuration of Electronic Control System S

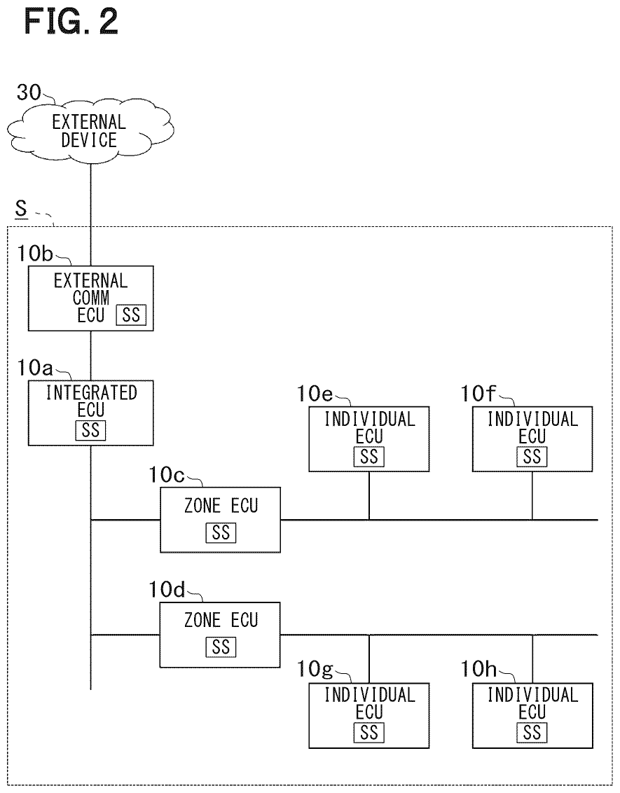

FIG. 2 is a diagram showing an example configuration of the electronic control system S. The electronic control system S is composed of multiple ECUs 10 and an in-vehicle network connecting them. FIG. 2 illustrates eight ECUs (ECU 10a to ECU 10h) as an example, and the electronic control system S can be composed of any number of ECUs. In the following description, when describing the entire single or multiple electronic control units collectively, they are referred to as ECU 10 or each ECU 10, and when describing individual electronic control units specifically, they are referred to as ECU 10a, ECU 10b, ECU 10c or the like.

In the case of FIG. 2, each ECU 10 is connected via an in-vehicle communication network such as CAN (Controller Area Network) or LIN (Local Interconnect Network). Alternatively, they may be connected using any communication method, wired or wireless, such as Ethernet (registered trademark), Wi-Fi (registered trademark), Bluetooth (registered trademark).

The term “connected” means a state where data exchange is possible, and it includes cases where different hardware is connected via a wired or wireless communication network, as well as cases where virtual ECUs (also called virtual machines) realized on the same hardware are virtually connected.

The electronic control system S shown in FIG. 2 includes an integrated ECU 10a, an external communication ECU 10b, zone ECUs (10c, 10d), and individual ECUs (10e to 10h).

The integrated ECU 10a is an ECU that has the function of controlling the entire electronic control system S and the gateway function of mediating communication between each ECU. The integrated ECU 10a may also be called a gateway ECU (G-ECU) or a mobility computer (MC). Additionally, the integrated ECU 10a may be a relay device or a gateway device.

The external communication ECU 10b is an ECU that has a communication unit for communicating with an external device 30 provided outside the vehicle. The communication method used by the external communication ECU 10b is the aforementioned wireless or wired communication method. Multiple external communication ECUs 10b may be provided to realize multiple communication methods. Alternatively, the integrated ECU 10a may include the function of the external communication ECU 10b instead of providing the external communication ECU 10b.

The zone ECUs 10c, 10d are ECUs equipped with gateway functions appropriately arranged according to the location or function where individual ECUs are placed. For example, zone ECU 10c is an ECU with a gateway function that mediates communication between individual ECUs 10e and 10f, which are placed at the front of the vehicle, and other ECUs 10. Zone ECU 10d is an ECU with a gateway function that mediates communication between individual ECUs 10g and 10h, which are placed at the rear of the vehicle, and other ECUs 10.

The individual ECUs 10e to 10h can be composed of ECUs with any function. For example, they can include drive system electronic control units that control the engine, steering, brakes or the like, body system electronic control units that control meters, power windows or the like, information system electronic control units such as navigation devices, or safety control system electronic control units that control to prevent collisions with obstacles or pedestrians. Additionally, the ECUs may not be parallel but classified into master and slave.

In the electronic control system S shown in FIG. 2, each ECU 10 except for ECU 10h is equipped with a security sensor module (referred to as a sensor module) (abbreviated as SS in FIG. 2). It is not necessary for all ECUs 10 constituting the electronic control system S to be equipped with sensor modules. The security logs generated by the sensor modules will be described later.

In each embodiment, the log generation device 100 or the like is described as being one of the individual ECUs 10e to 10g. However, the log generation device 100 or the like can be provided in any ECU equipped with a sensor module, and may be provided in the integrated ECU 10a, the external communication ECU 10b or the zone ECUs (10c to 10d).

Additionally, in each embodiment, the log collection device 20 is described as being the external communication ECU 10b. However, the log collection device can also be provided in the integrated ECU 10a, the zone ECUs 10c to 10d, or the individual ECUs 10e to 10h. When one of the individual ECUs 10e to 10h is used as the log collection device 20, it may be desirable to use a dedicated ECU to realize the log collection device 20.

### 2. FIRST EMBODIMENT

### (1) Log Generation Device 100

### (a) Configuration of Log Generation Device 100

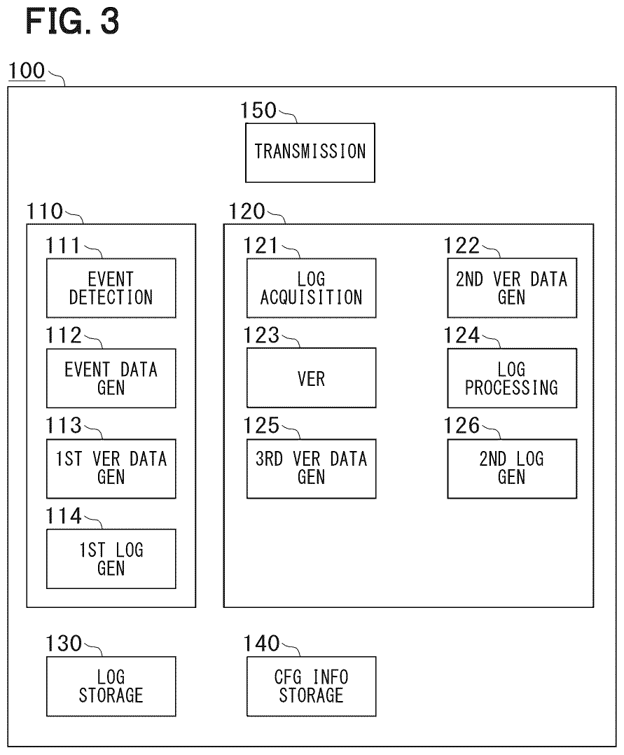

Referring to FIG. 3, an example configuration of the log generation device 100 of this embodiment will be described. The log generation device 100 includes a sensor module 110 and a log generation module 120. The log generation device 100 further includes a log storage unit 130, which is a storage unit, a configuration information storage unit 140, and a transmission unit 150, which is a communication interface. The log generation device 100, which is an individual ECU, has functions related to the vehicle (for example, in the case of a drive system electronic control unit, functions related to the driving of the vehicle), but these are omitted in FIG. 3.

The sensor module 110 is a module that detects events and generates logs, and is also referred to as a security sensor. The sensor module 110 includes an event detection unit 111, an event data generation unit 112, a first verification data generation unit 113, and a first log generation unit 114.

The event detection unit 111 detects events that occur in the ECU or the in-vehicle communication network connected to the ECU. For example, the event detection unit 111 detects abnormal behavior as an event when the ECU or the in-vehicle network exhibits abnormal behavior due to cyber-attacks. The event detection unit 111 may detect not only abnormal behavior but also normal operations as events.

The event data generation unit 112 generates “event data” indicating the detected event when the event detection unit 111 detects an event. Here, “event data” may be any information related to the event, including information indicating the type of event, the location where the event occurred, the sensor that detected the event, the time or the like.

The first verification data generation unit 113 generates “verification data” (corresponding to “first verification data”) to verify the authenticity of the event data generated by the event data generation unit 112. In this embodiment, the verification data is explained using an example where the verification data is a hash value, and the hash value generated by the first verification data generation unit 113 is referred to as a hash value X.

Here, “verification data” refers to data used to verify the authenticity of the event data, and examples include a hash value, a CRC value, a checksum, or data obtained by encrypting or decrypting these values.

The verification data is not limited to a hash value and may be, for example, CRC, checksum, or encrypted versions of a hash value, CRC, or checksum. The data used as verification data may be selected according to the security requirements, error detection rate, and/or processing load required for the log generation device 100. For example, CRC and checksum are known to have relatively low processing loads for generating these data. Therefore, when verification data with a low processing load is required, CRC or checksum is adopted as the verification data. On the other hand, a hash value and a digital signature are known to have high error detection accuracy, so when high error detection accuracy is required, a hash value or a digital signature may be adopted as the verification data.

Furthermore, the first verification data generation unit 113 does not need to generate the hash value X for all event data generated by the event data generation unit 112. The first verification data generation unit 113 refers to the verification data necessity information stored in the configuration information storage unit 140, which will be described later, and determines whether to generate verification data for the event data. The first verification data generation unit 113 generates the hash value X only when it determines that verification data should be generated based on the verification data necessity information.

The first log generation unit 114 generates a security log (corresponding to “first security log”) that includes the event data generated by the event data generation unit 112 and the hash value X generated by the first verification data generation unit 113, and stores the generated security log in the log storage unit 130. The security log generated by the log generation unit 114 is referred to as log A. In the specifications defined by AUTOSAR (AUTomotive Open System ARchitecture), the security log generated by the sensor module 110 is called SEv.

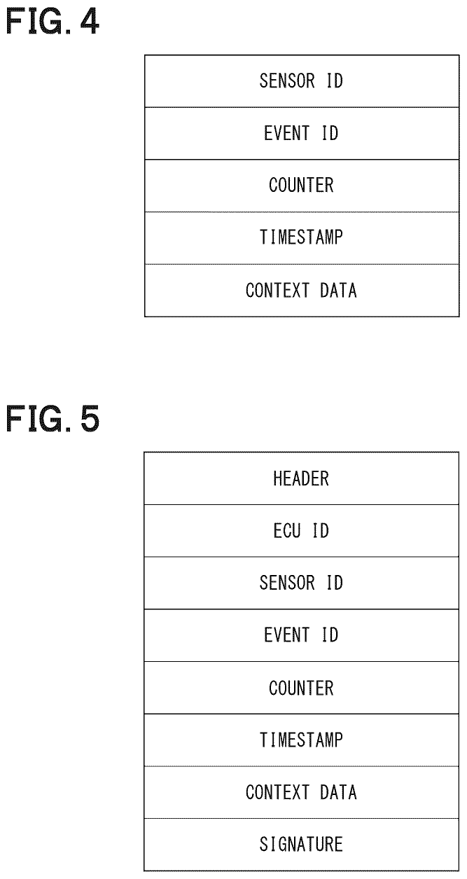

FIG. 4 is a diagram showing a specific example of a log A generated by the first log generation unit 114. The log A has fields for sensor ID indicating the identification information of the security sensor, an event ID indicating the identification information of the event, a counter indicating the number of occurrences of the event, a timestamp indicating the time of occurrence of the event, and a context data indicating the details of the output of the security sensor. The log A shown in FIG. 4 is just an example and does not necessarily have to include all the fields shown in FIG. 4.

In this embodiment, the event data generation unit 112 generates a sensor ID, an event ID, a counter, a timestamp, and a context data as an event data. The first verification data generation unit 113 generates the hash value X as verification data for these data. The first log generation unit 114 generates the log A by storing the hash value X in the context data field. The hash value X and the log A will be described in detail later.

The log storage unit 130 is a storage unit that stores the log A generated by the first log generation unit 114 of the sensor module 110. The configuration information storage unit 140 is a storage unit that stores verification data necessity information indicating whether to generate verification data for the event data. The verification data necessity information is stored, for example, in association with the event ID. Therefore, the first verification data generation unit 113 can determine whether to generate verification data for the event data by referring to the verification data necessity information associated with the event ID generated by the event data generation unit 112. The configuration information storage unit 140 further stores log management information indicating the handling of logs in the log generation module 120. The log management information will be described later.

The log storage unit 130 and the configuration information storage unit 140 may be external storage devices (hard disks, USB memory, CD/BD or the like.) or internal storage devices (RAM or the like). They may be volatile or non-volatile.

Next, the log generation module 120 will be described. The log generation module 120 is a module that generates a log to be sent to the log collection device 20 based on the log generated by the sensor module 110. The log generation module 120 includes a log acquisition unit 121, a second verification data generation unit 122, a verification unit 123, a log processing unit 124, a third verification data generation unit 125, and a second log generation unit 126. The log generation module 120 is also referred to as IdsM (Intrusion Detection System Manager) in the specifications defined by AUTOSAR.

The log acquisition unit 121 acquires the log A generated by the sensor module 110 from the log storage unit 130.

The second verification data generation unit 122 generates verification data (corresponding to “second verification data”) using the event data included in the log A acquired by the log acquisition unit 121. Specifically, the second verification data generation unit 122 generates a hash value using the data from the log A excluding the hash value X. The verification data generated by the second verification data generation unit 122 is referred to as a hash value Y.

The verification unit 123 compares the hash value X included in the log A with the hash value Y generated by the second verification data generation unit 122 to “verify the identity” of the hash value X and the hash value Y. Here, “verify the identity” means verifying whether the two verification data can be evaluated as identical. For example, even if one data is encrypted and the other is not, if the unencrypted data or the encrypted data are identical, these verification data are evaluated as identical.

If the verification unit 123 determines that the hash value X and the hash value Y are not identical, the log processing unit 124 processes the log based on the log management information stored in the configuration information storage unit 140. Specifically, if the log management information indicates that a log for which the identity of the hash values cannot be verified should be discarded, the log processing unit 124 discards the log A. Alternatively, if the log management information indicates that a log for which the identity of the hash values cannot be verified should be saved, the log processing unit 124 may save the log A in the log storage unit 130 or in an external storage unit (not shown) provided outside the log generation device 100.

The log processing unit 124 may also process the log A that does not contain a hash value. For example, if the verification data necessity information indicates that verification data should be generated for the event data, but the log A does not contain verification data, the log A may be damaged or tampered with due to a cyber-attack. In such cases, the log processing unit 124 may discard the log A or save the log A based on the log management information.

On the other hand, if the verification unit 123 determines that the hash value X and the hash value Y are identical, the third verification data generation unit 125 generates a new verification data (corresponding to “third verification data”). The verification data generated by the third verification data generation unit 125 is verification data used to verify the authenticity of the event data in the log collection device 20, which will be described later. The verification data generated by the third verification data generation unit 125 is referred to as a hash value a. The verification data generated by the third verification data generation unit 125 is not limited to a hash value.

The second log generation unit 126 generates a security log to be sent to the log collection device 20. Specifically, the second log generation unit 126 generates a security log that includes the event data and the hash value a generated by the third verification data generation unit 125. The log generated by the second log generation unit 126 is referred to as a log B (corresponding to “second security log”). In the specifications defined by AUTOSAR, the security log generated by the log generation module 120 is called QSEv.

FIG. 5 is a diagram showing a specific example of the log B generated by the second log generation unit 126. The log B has fields for a sensor ID, an event ID, a counter, a timestamp, and a context data, which are the same fields as the log A, as well as fields for ECU ID indicating the identification information of the ECU 10, which is the log generation device 100, a header storing information indicating the protocol version and the state of each field, and a signature field storing the hash value a generated by the third verification data generation unit 125.

In this embodiment, the second log generation unit 126 generates the log B by storing the hash value a generated by the third verification data generation unit 125 in the signature field. The hash value a and the log B will be described in detail later.

If the log acquisition unit 121 acquires multiple logs A with common event types, the second log generation unit 126 may generate a single log B from multiple logs A. In this case, the verification unit 123 verifies the verification data for all logs A, and the log B is generated from logs A for which the identity of the verification data has been verified.

Additionally, in each embodiment, the log generation module 120 is described as always generating the log B and sending it to the log collection device 20 when the hash value X and the hash value Y are identical. However, the log generation module 120 may be configured to generate the log B and send it to the log collection device 20 only when the event data meets certain conditions. For example, as mentioned above, the sensor module 110 may detect normal behavior as an event and generate the log A. Therefore, the log generation module 120 may generate the log B only when the event data indicates an abnormal event. Alternatively, the log B may be generated only when the timing of the event occurrence, the frequency of the event occurrence, the number of logs A with common event types or the like meet certain conditions.

The transmission unit 150 sends the log B generated by the second log generation unit 126 to the log collection device 20 via the in-vehicle network.

### (b) Generation and Verification of Verification Data

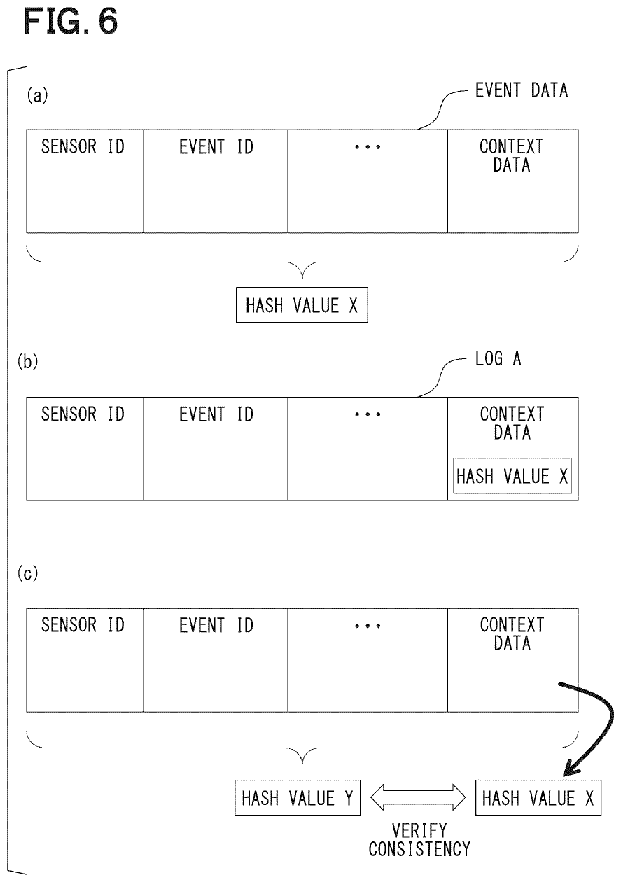

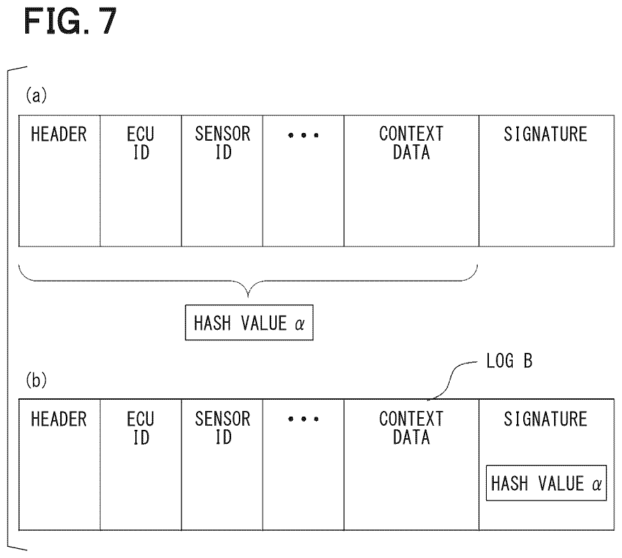

Next, referring to FIG. 6 and FIG. 7, the verification data generated by the first verification data generation unit 113, the second verification data generation unit 122, and the third verification data generation unit 125, and the verification of the identity of the verification data by the verification unit 123 will be described.

A part (a) of FIG. 6 is a diagram schematically showing the event data, which includes a sensor ID, an event ID, and context data, generated by the event data generation unit 112. The first verification data generation unit 113 generates the hash value X using the event data shown in the part (a) of FIG. 6. Then, the first log generation unit 114 generates the log A shown in a part (b) of FIG. 6. As shown in the part (b) of FIG. 6, the log A is generated by storing the hash value X generated in the part (a) of FIG. 6 in the context data.

The second verification data generation unit 122 generates the hash value Y based on data excluding the hash value X stored in the context data from the log shown in the part (b) of FIG. 6. A part (c) of FIG. 6 shows the hash value Y generated by the second verification data generation unit 122. The verification unit 123 verifies the identity of the hash value X stored in the context data and the hash value Y generated.

A part (a) of FIG. 7 is a diagram explaining the hash value a generated by the third verification data generation unit 125. In this example, the hash value a is generated using a header, ECU ID, a sensor ID included in the log A, an event ID, and event data that is context data. Then, as shown in a part (b) of FIG. 7, the log B is generated by storing the hash value a generated in the part (a) of FIG. 7 in the signature.

### (c) Operation of the Log Generation Device

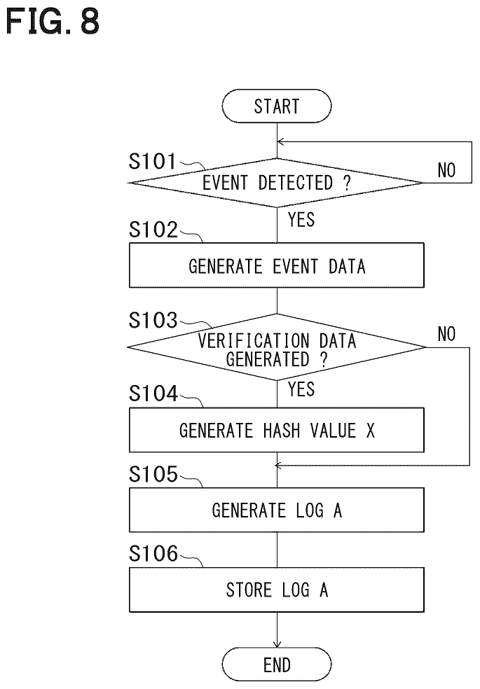

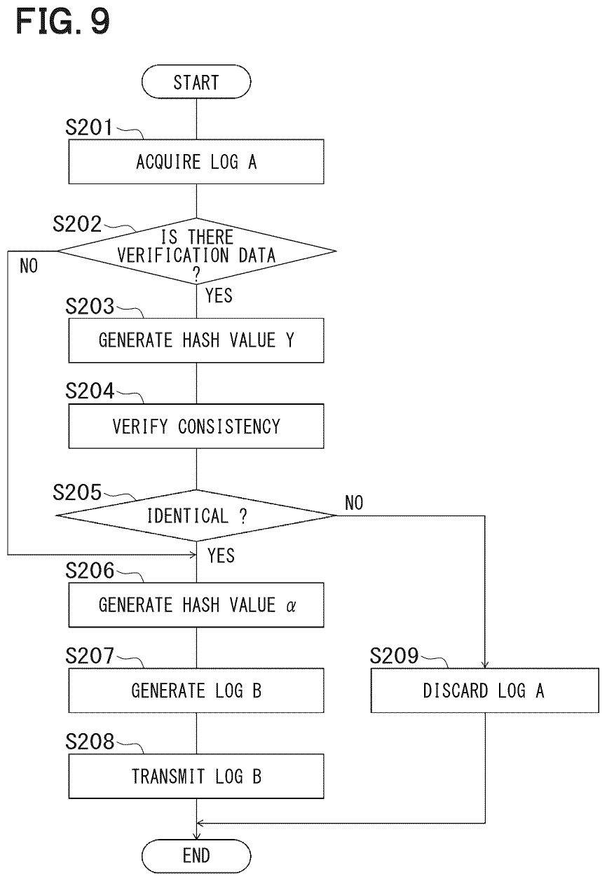

Next, referring to FIG. 8 and FIG. 9, the operation of the log generation device 100 will be described. FIG. 8 and FIG. 9 not only show the log generation method executed by the log generation device 100 but also indicate the processing steps of a log generation program executable by the log generation device 100. These processes are not limited to the order shown in FIG. 8 and FIG. 9. That is, unless there is a constraint such as a relationship where the result of a preceding step is used in a subsequent step, the order can be rearranged. The same applies to the log collection method of the log collection device 20 described later and the log generation methods in each embodiment.

FIG. 8 is a diagram explaining the operation of the sensor module 110 of the log generation device 100. When the event detection unit 111 of the sensor module 110 detects an event (S101: Y), the event data generation unit 112 generates event data indicating the event detected in S101 (S102). The first verification data generation unit 113 refers to the verification data necessity information stored in the configuration information storage unit 140 and determines whether to generate verification data for the event data generated in S102 (S103). If it is determined to generate verification data (S103: Y), the verification data generation unit 113 generates the hash value X (S104). The first log generation unit 114 generates the log A, which includes the event data generated in S102 and the hash value X generated in S104 (S105). The first log generation unit 114 stores the log A generated in S105 in the log storage unit 130 (S106).

FIG. 9 is a diagram explaining the operation of the log generation module 120 and the transmission unit 150 of the log generation device 100. The log acquisition unit 121 of the log generation module 120 acquires the log A generated by the sensor module 110 from the log storage unit 130 (S201). If the log A acquired in S201 contains verification data (S202: Y), the second verification data generation unit 122 generates the hash value Y using the event data included in the log A (S203). The verification unit 123 verifies the identity of the hash value X included in the log A and the hash value Y generated in S204 (S204). If the verification result in S204 shows that the hash value X and the hash value Y are identical (S205: Y), the third verification data generation unit 125 generates the hash value a (S206). The second log generation unit 126 generates the log B, which includes the event data and the hash value a generated in S206 (S207). The transmission unit 150 sends the log B generated in S207 to the log collection device 20 (S208). On the other hand, if the hash value X and the hash value Y are not identical in S205 (S205: N), the log A is discarded (S209).

### (2) Log Collection Device

### (a) Configuration of the Log Collection Device

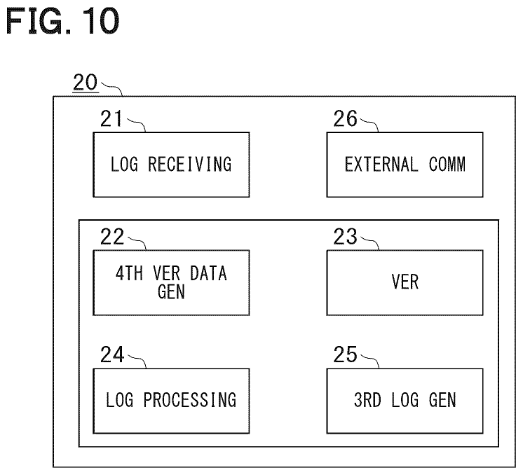

Next, referring to FIG. 10, an example configuration of the log collection device 20 will be described. The log collection device 20 includes a log reception unit 21, a fourth verification data generation unit 22, a verification unit 23, a log processing unit 24, a third log generation unit 25, and an external communication unit 26. The log collection device 20 is also referred to as IdsR (Intrusion Detection System Reporter) in the specifications defined by AUTOSAR.

The log reception unit 21 receives the log B sent from the transmission unit 150 of the log generation device 100.

The fourth verification data generation unit 22 generates verification data (corresponding to “fourth verification data”) using the event data included in the log B received by the log reception unit 21. Specifically, the fourth verification data generation unit 22 generates a hash value using the data from the log B excluding the signature field. In this embodiment, the hash value is generated using the header, ECU ID, and event data. The verification data generated by the fourth verification data generation unit 22 is referred to as a hash value β.

The verification unit 23 compares the hash value α included in the log B with the hash value β generated by the fourth verification data generation unit 22 to “verify the identity” of the hash value α and the hash value β.

If the verification unit 23 determines that the hash value α and the hash value β are not identical, the log processing unit 24 discards the log B.

On the other hand, if the verification unit 23 determines that the hash value α and the hash value β are identical, the third log generation unit 25 generates an external transmission log based on the log B to be sent to the external device 30. The external transmission log is a log that notifies the external device 30 that an event has occurred within the electronic control system S, and therefore includes event data indicating the detected event. The third log generation unit 25, for example, aggregates the contents of multiple logs B, which have been determined to have identical hash values α and β, and generates an external transmission log. Aggregating the contents of logs B means, for example, combining the information contained in each field of multiple logs B into a single log. By combining multiple logs B into a single external transmission log, the data volume of logs sent from the electronic control system S can be reduced, thereby reducing the communication load with the external device 30. Alternatively, the third log generation unit 25 may generate the external transmission log by directly using the log B received by the log reception unit 21.

Here, “based on the log” means not only generating a new log using the log as an external transmission log but also using the log itself as the external transmission log.

The external communication unit 26 sends the external transmission log generated by the third log generation unit 25 to the external device 30. If the log collection device 20 is provided in an ECU other than the external communication ECU 10b, the external transmission log is sent to the external device 30 via the external communication ECU 10b.

### (b) Operation of the Log Collection Device

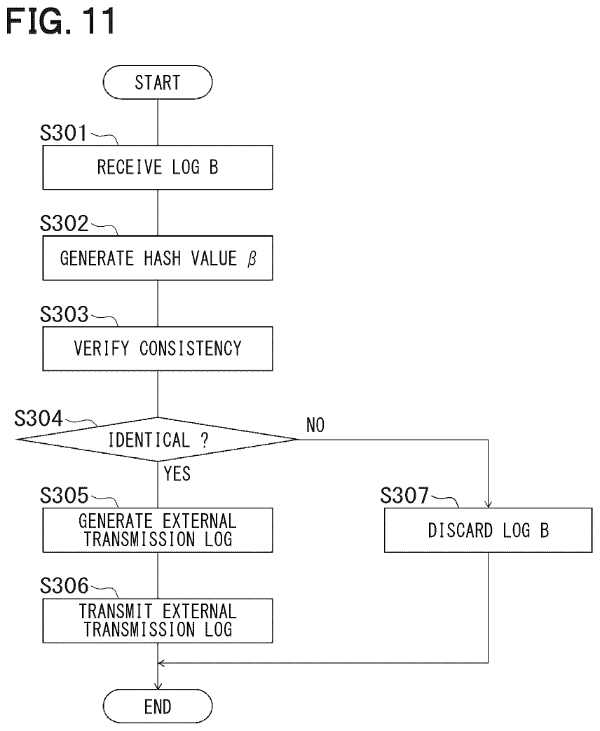

Next, referring to FIG. 11, the operation of the log collection device 20 will be described. The log reception unit 21 receives the log B sent from the log generation module 120 of the log generation device 100 (S301). The fourth verification data generation unit 22 generates the hash value β, which is verification data, using the event data included in the log B received in S301 (S302). The verification unit 23 verifies the identity of the hash value a included in the log B and the hash value β generated in S302 (S303). If the verification result in S303 shows that the hash value α and the hash value β are identical (S304: Y), the third log generation unit 25 generates an external transmission log based on the log B (S305). The external communication unit 26 sends the external transmission log generated in S305 to the external device 30 (S306). On the other hand, if the hash value α and the hash value β are not identical in S304 (S304: N), the log B is discarded (S307).

### (3) Overview

According to this embodiment, by performing integrity verification using verification data on the logs generated by the sensor module 110 of the log generation device 100, it is possible to prevent damaged or tampered logs due to cyber-attacks from being sent to the log collection device.

### 3. SECOND EMBODIMENT

In the first embodiment, the log generation module 120 generates new verification data using event data and stores the generated verification data in the signature to generate a log. In this embodiment, the configuration is explained where the log is generated using the verification data generated by the sensor module 110. The log generation device of this embodiment will be described focusing on the differences from the first embodiment.

### (1) The Log Generation Device

### (a) Configuration of the Log Generation Device

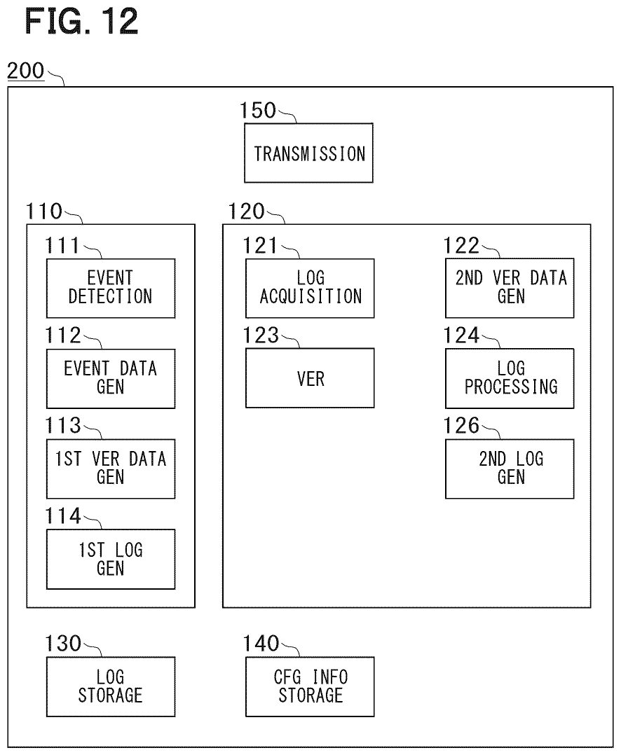

FIG. 12 is a diagram explaining an example configuration of the log generation device 200 of this embodiment. The log generation device 200 of this embodiment differs from the log generation device 100 of the first embodiment in that it does not have the third verification data generation unit 125.

The second log generation unit 126 of this embodiment generates the log B in the same manner as in the first embodiment. However, the verification data included in the log B of this embodiment is either the hash value X generated by the first verification data generation unit 113 or the hash value Y generated by the second verification data generation unit 122. Since the identity of the hash value X and the hash value Y is verified by the verification unit 123, the hash value included in the log B can be either value. In this embodiment, the case where the log B includes the hash value X is explained as an example.

In this embodiment, the log generation module 120 does not need to generate a new hash value. As a result, compared to the first embodiment, the processing load on the log generation module 120 can be reduced. Additionally, the hash value X can be stored in the context data, similar to the log A. Therefore, the log B of this embodiment does not need to have a signature field. Consequently, the data volume of the log B is smaller compared to the first embodiment, reducing the communication load between ECUs 10.

### (b) Logs Generated by the Log Generation Device

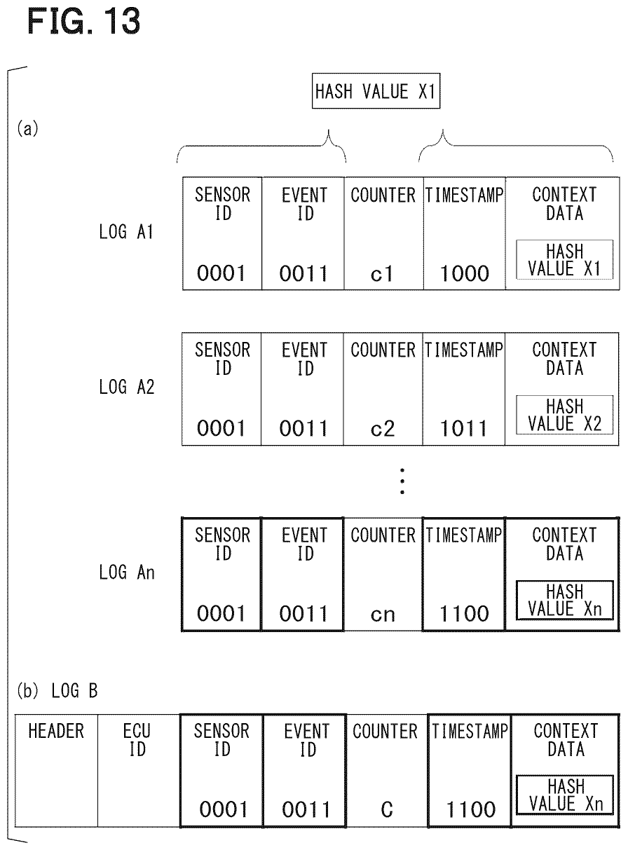

Next, referring to FIG. 13, logs A and B of this embodiment will be explained. A part (a) of FIG. 13 shows multiple logs A1 to An (n being a natural number) generated by the first log generation unit 114 of the sensor module 110 and acquired by the log acquisition unit 121 of the log generation module 120. Logs A1 to An, generated by the same sensor module 110 and having common event types, have common sensor IDs and event IDs. However, the values stored in the counter indicating the number of event occurrences differ for each log. Therefore, in the part (a) of FIG. 13, the values stored in the counter are indicated as c1, c2, . . . cn. Additionally, the values of the timestamps indicating the event occurrence time differ for each log.

In this embodiment, the first verification data generation unit 113 of the sensor module 110 generates the hash value X1 based on the values of the fields excluding the counter, and the first log generation unit 114 stores the generated hash value X1 in the context data to generate the log A1. The same applies to logs A2 and An. As mentioned above, logs A1 to An have common sensor IDs and event IDs, but the values of the timestamps differ for each log. Therefore, the hash values X1 to Xn stored in each log differ.

A part (b) of FIG. 13 shows the log B generated by the second log generation unit 126 of the log generation module 120 based on logs A1 to An. Similar to the first embodiment, the log B is assigned a header and ECU ID. Additionally, the counter of the log B stores the total value (C) of the counter values (c1 to cn) of logs A1 to An used to generate the log B. In the example shown in the part (b) of FIG. 13, the log B stores the same sensor ID, event ID, timestamp, and hash value as the log An. Thus, the log B includes the event data (corresponding to “specific event data”) and a hash value Xn included in the most recent log An (corresponding to “specific security log”) generated by the sensor module 110. In the part (b) of FIG. 13, the log B stores the hash value Xn included in the log An, but it may store the hash value Yn generated by the second verification data generation unit 122 instead of the hash value Xn.

Here, in FIG. 13, an example is explained where the log B is generated including the data stored in the most recent log An generated by the sensor module 110. However, instead of the most recent log An, the log B may be generated including the data stored in the oldest log (i.e., the log A1) generated by the sensor module 110.

### (c) Operation of the Log Generation Device

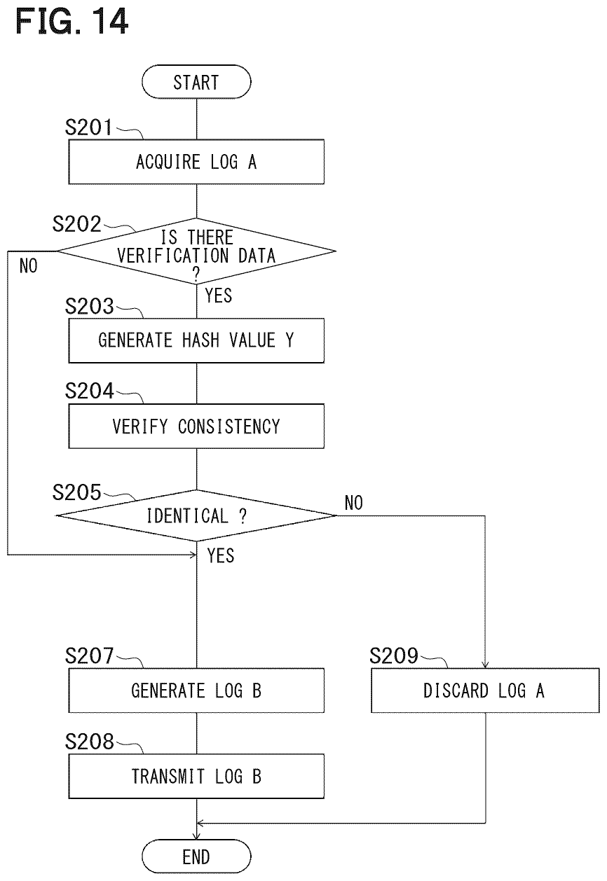

Next, referring to FIG. 14, the operation of the log generation module 120 of the log generation device 200 of this embodiment will be explained. The same processes as in the first embodiment are indicated by the same reference numerals in FIG. 9, and the explanation is omitted.

In this embodiment, if the identity verification of the hash values shows that the hash value X and the hash value Y are identical (S205: Y), the log B is generated without generating the hash value α (S207). Here, the hash value included in the log B generated in S207 is either hash value X or the hash value Y.

### (2) Log Collection Device

The log collection device 20 of this embodiment operates in the same manner as the log collection device 20 of the first embodiment. However, in the first embodiment, the identity of the hash value a included in the signature of the log B and the hash value β generated by the fourth verification data generation unit 22 of the log collection device 20 was verified. In this embodiment, the identity of the hash value X or the hash value Y included in the context data of the log B and the hash value generated by the fourth verification data generation unit 22 is verified. The hash value generated by the fourth verification data generation unit 22 of this embodiment is referred to as hash value Z. The fourth verification data generation unit 22 generates hash value Z using the sensor ID, event ID, and timestamp of the log B and verifies the identity of the hash value X or the hash value Y and hash value Z.

### (3) Overview

According to this embodiment, by reusing the hash value used for identity verification in the log generation module 120 for identity verification in the log collection device 20, the processing load on the log generation module 120 can be reduced.

### 4. THIRD EMBODIMENT

In the first and second embodiments, the log generation module 120 always verifies the identity of the verification data if the acquired log contains verification data. In this embodiment, the configuration is explained where the identity verification of the verification data is determined based on the importance of the log.

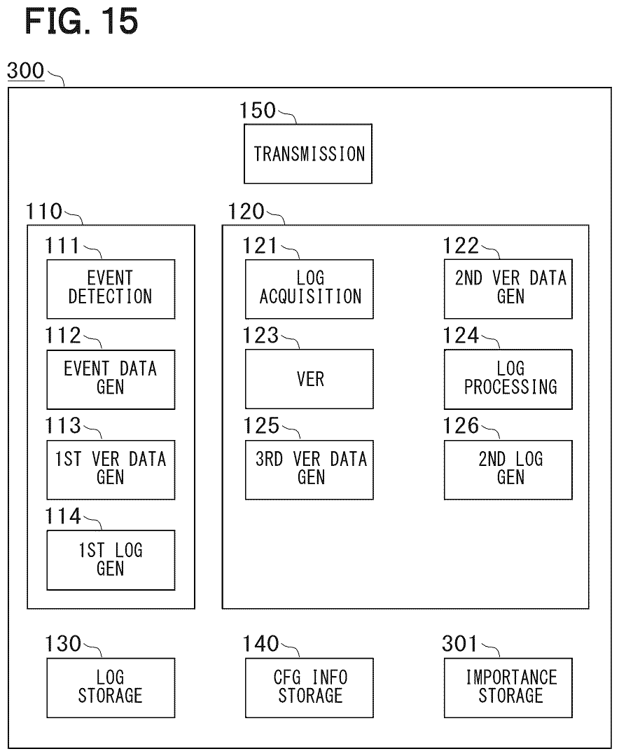

Referring to FIG. 15, the log generation device 300 of this embodiment will be explained. The log generation device 300 of this embodiment differs from the log generation devices of the first and second embodiments in that it includes an importance storage unit 301. For example, the importance storage unit 301 stores the event ID identifying the event and the importance set according to the event in association with each other. Here, multiple importance may be associated with the same event depending on the state of the vehicle. For example, when the vehicle is stopped, a low importance is associated with the event ID, while when the vehicle is running, a high importance is associated with the same event ID.

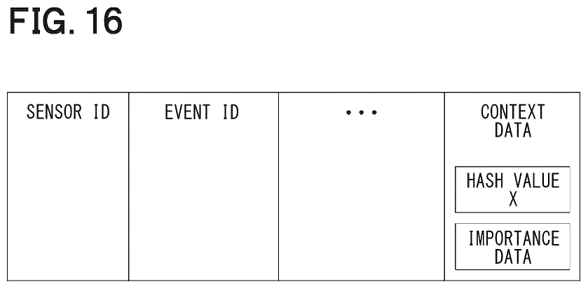

In this embodiment, when the first log generation unit 114 generates the log A, it stores the importance data indicating the importance associated with the event in the importance storage unit 301 in the context data along with the hash value X. The importance data is data indicating the “importance” set according to the event detected by the event data generation unit 112. FIG. 16 is a diagram schematically showing the log A of this embodiment. The context data includes the hash value X and the importance data.

Here, “importance” is an index classified based on a predetermined evaluation criterion, and the number of classifications can be multiple. “Indicating importance” includes both information that directly indicates importance and information that indirectly indicates importance.

When the log acquisition unit 121 of the log generation module 120 acquires the log A, it determines whether to perform identity verification based on the importance data included in the context data. Specifically, the second verification data generation unit 122 determines to perform identity verification if the importance indicated by the importance data is higher than a predetermined importance and generates the second verification data. On the other hand, if the importance indicated by the importance data is lower than the predetermined importance, the second verification data generation unit 122 determines not to perform identity verification and does not generate the second verification data. “Higher than” includes both cases where the comparison target includes the same value and does not include the same value.

In the above example, the case where the importance data is stored in the log A was explained, but the importance data may not be stored in the log A, and the second verification data generation unit 122 may refer to the importance storage unit 301 to determine the importance of the log A. Specifically, when the log acquisition unit 121 acquires the log A, it refers to the importance storage unit 301 to obtain the importance associated with the event ID included in the log A. Then, if the “importance” associated with the event ID is higher than the predetermined importance, it determines to perform identity verification. On the other hand, if the importance indicated by the importance data is lower than the predetermined importance, it determines not to perform identity verification.

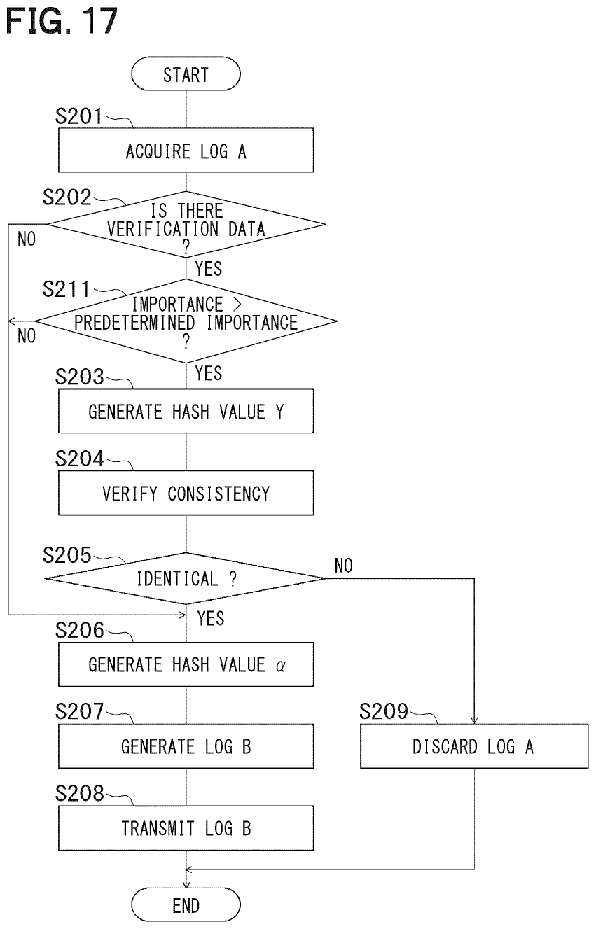

Next, referring to FIG. 17, the operation of the log generation module 120 of the log generation device 300 of this embodiment will be explained. The same processes as in the first embodiment are indicated by the same reference numerals in FIG. 9, and the explanation is omitted.

In this embodiment, if the context data contains verification data (S202), it further determines whether the importance of the event indicated by the event data included in the log A is higher than the predetermined importance (S211). If the importance is higher than the predetermined importance (S211: Y), the second verification data generation unit 122 generates the second verification data (S203).

According to this embodiment, identity verification of the verification data can be performed only for events with high importance. As a result, while suppressing the processing load on the log generation device, it is possible to prevent logs containing event data with high importance from being sent to the log collection device if they are damaged or tampered with due to cyber-attacks.

### 5. FOURTH EMBODIMENT

In this embodiment, the configuration is explained where the identity verification using verification data is performed according to the processing load of the log generation device.

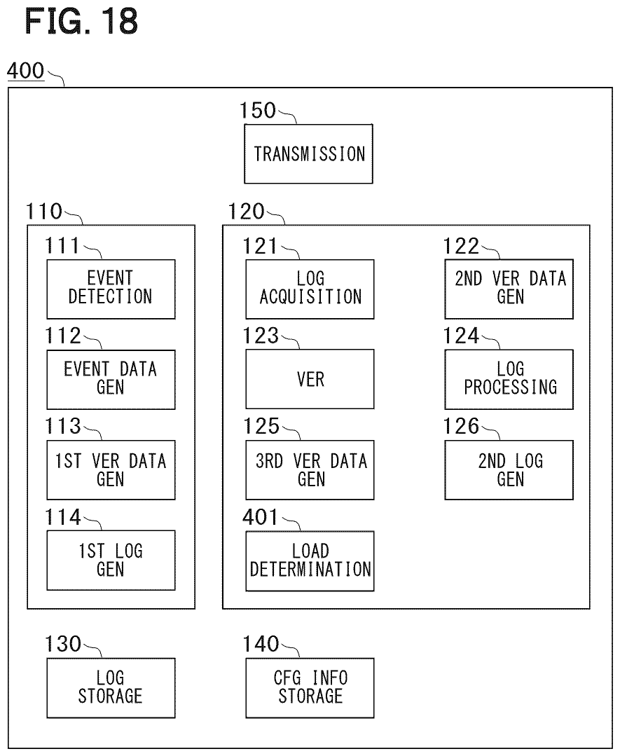

Referring to FIG. 18, the log generation device 400 of this embodiment will be explained. The log generation device 400 of this embodiment differs from the log generation devices of the first to third embodiments in that the log generation module 120 includes a load determination unit 401. The load determination unit 401 determines the processing load of the log generation device 400.

According to the processing load of the log generation device 400 determined by the load determination unit 401, the second verification data generation unit 122 changes the frequency of generating the second verification data. As a result, the frequency of identity verification performed by the verification unit 123 also changes. Here, the frequency of identity verification performed by the verification unit 123 is lower when the processing load is high (corresponding to the “first processing load”) compared to when the processing load is low (corresponding to the “second processing load”). For example, if the processing load of the log generation device 400 determined by the load determination unit 401 is higher than a predetermined value, the second verification data generation unit 122 reduces the frequency of generating the second verification data. As a result, the frequency of identity verification performed by the verification unit 123 decreases. Specifically, the second verification data is not generated for all logs A acquired by the log acquisition unit 121, and for example, the second verification data is generated only for one of the two logs A acquired by the log acquisition unit 121, thereby reducing the frequency of identity verification.

The generation of verification data and the identity verification are processes with relatively high computational load, and the processing load on the log generation device is high. According to this embodiment, by changing the frequency of identity verification according to the processing load of the log generation device 400, it is possible to prevent the processing load on the log generation device 400 from becoming excessively high.

### 6. Modifications

### (1) First Modification

In the first embodiment described above, the log generation module 120 generates logs by storing the verification data used by the log collection device 20 for verification in the signature. In the second embodiment, the verification data is stored in the context data instead of the signature. In this modification, the log generation module 120 selects whether to store the verification data in the signature or the context data.

The configuration of the log generation device in this modification is the same as the log generation device 100 of the first embodiment. However, in this modification, for example, depending on the content of the event or the security sensor that detected the event, the second log generation unit 126 determines whether to store the verification data in the signature or the context data and generates the log B as described in the first embodiment or the second embodiment.

The configuration of the log collection device in this modification is also the same as the log collection device 20 described in the first embodiment or the second embodiment. However, in this modification, when the log reception unit 21 receives the log B, it determines whether to use the verification data stored in the signature or the context data for verification.

For example, the verification unit 23 of the log collection device 20 determines whether to use the verification data stored in the signature or the context data for verification based on the sensor ID or event ID stored in the log B. Alternatively, the context data of the log B may store information indicating the field where the verification data is stored. In this case, the verification unit 23 determines whether to use the verification data stored in the signature or the context data based on this information.

In the first embodiment and the second embodiment, the data used to generate the verification data differs. For example, in the first embodiment, as shown in the part (a) of FIG. 7, the hash value a is generated using data from the header to the context data, whereas in the second embodiment, as shown in the part (b) of FIG. 13, the hash value Xn is generated using only predetermined data (e.g., sensor ID, event ID, timestamp). Therefore, in the log collection device 20, the field data used to generate the verification data also differed depending on the field included in the log B. In this modification, the fourth verification data generation unit 22 of the log collection device 20 generates the verification data using different data depending on whether the verification data is stored in the signature or the context data. Therefore, in this modification, it is necessary to determine whether the verification data is stored in the signature or the context data of the log B.

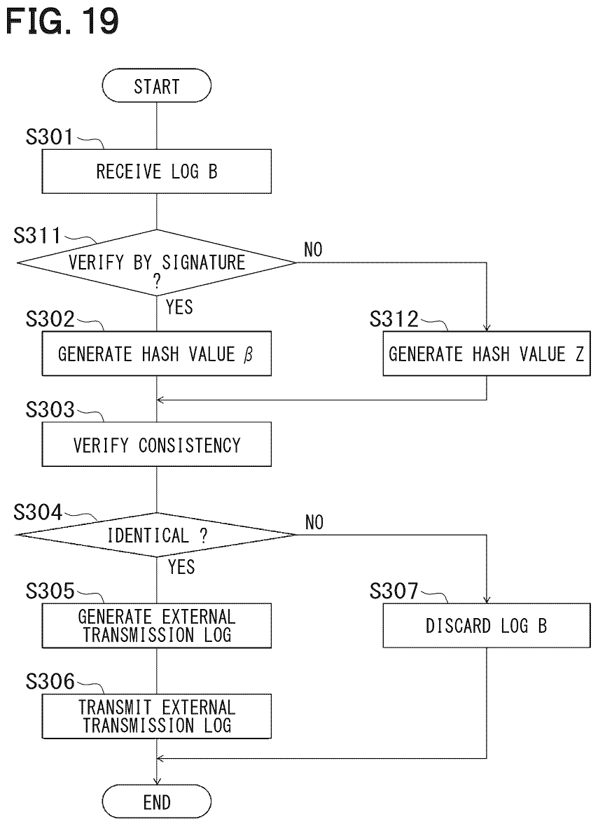

FIG. 19 is a diagram explaining an example operation of the log collection device 20 in this modification. In this modification, when the log B is received from the log generation device 100 (S301), it is determined whether to perform verification using the verification data stored in the signature of the log B (S311). If it is determined to perform verification using the signature (S311: Y), as in the first embodiment, the hash value β is generated based on the data stored in the fields other than the signature of the log B (S302), and identity verification is performed (S303). On the other hand, if it is determined not to perform verification using the signature (S311: N), as in the second embodiment, the hash value Z is generated (S312). Then, the identity verification of the hash value X or Y stored in the context data and the hash value Z is performed (S303).

### (2) Second Modification

In the embodiments described above, the case where the hash value is used as the verification data was explained as an example. In this modification, the case where a digital signature is used as the verification data is explained.

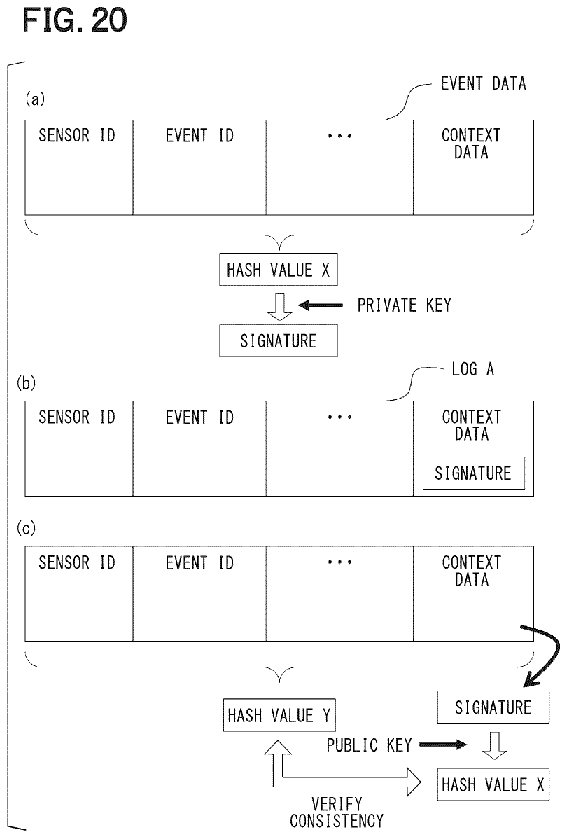

Referring to FIG. 20, the case where a signature is generated as the verification data is explained. As shown in a part (a) of FIG. 20, the first verification data generation unit 113 generates the hash value X using the event data, as in the embodiments described above. However, in this modification, the first verification data generation unit 113 further encrypts the generated hash value X with a private key to create a digital signature. Then, the first log generation unit 114 generates the log A as shown in a part (b) of FIG. 20. As shown in the part (b) of FIG. 20, the log A is generated by storing the digital signature created in the part (a) of FIG. 20 in the context data.

When the log acquisition unit 121 acquires the log A, the second verification data generation unit 122 generates the hash value Y based on the data excluding the digital signature stored in the context data of the log A shown in the part (b) of FIG. 20. A part (c) of FIG. 20 shows the hash value Y generated by the second verification data generation unit 122. Additionally, the second verification data generation unit 122 decrypts the digital signature stored in the context data with a public key to generate the hash value X. Then, the verification unit 123 verifies the identity of the hash value X generated by decrypting the digital signature and the hash value Y generated using the event data.

### (3) Third Modification

In the embodiments described above, the log processing unit 124 discards or stores the log based on the log management information stored in the configuration information storage unit 140 when the hash values X and Y are not identical. In this modification, the log management information is stored in the log A, and the log processing unit 124 discards or stores the log based on the log management information included in the log A when the hash values X and Y are not identical.

In this modification, when the first log generation unit 114 generates the log A, it stores the log management information indicating how to process the log if the hash values X and Y are not identical in the context data. Then, if the verification unit 123 verifies that the verification data are not identical, the log processing unit 124 discards or stores the log A based on the log management information stored in the context data of the log A.

### 7. Overview

The features of the log generation device and other aspects of the present disclosure in each embodiment have been described above.

The terms used in each embodiment are illustrative and may be replaced with synonymous terms or terms including synonymous functions.

The block diagrams used in the explanation of the embodiments classify and organize the configuration of the device by function. The blocks indicating each function can be realized by any combination of hardware or software. Since they indicate functions, these block diagrams can also be understood as disclosures of method disclosure s and disclosure s of programs that realize the methods.

The processes, flows, and functional blocks that can be understood as methods described in each embodiment can be rearranged unless there are constraints such as a step utilizing the result of a preceding step.

The terms “first,” “second,” to “Nth” (N is an integer) used in each embodiment and the disclosure are used to distinguish two or more configurations or methods of the same kind and do not limit the order or superiority.

Examples of forms of the log generation device in the invention include the following forms. Examples of the form of the component include a semiconductor element, an electronic circuit, a module, and a microcomputer. Examples of a form of a semi-finished product include an electric control unit (ECU) and a system board. Examples of a form of a finished product include a cellular phone, a smartphone, a tablet computer, a personal computer (PC), a workstation, and a server. Further, the security management device may be a device having a communication function such as a video camera, a still camera, a car navigation system.

Necessary functions such as an antenna or a communication interface may be added to the log generation device.

The device can be implemented not only by dedicated hardware having the configurations and functions described in the embodiments, but also by a combination of a program, which is recorded on a storage medium such as a memory or a hard disk and is used for implementing the above configuration and features, and general-purpose hardware that has a dedicated or general-purpose CPU that can execute the program, a memory, and the like.

A program stored in a non-transitory tangible storage medium (for example, an external storage device (a hard disk, a USB memory, and a CD/BD) of dedicated or general-purpose hardware, or an internal storage device (a RAM, a ROM, and the like)) may also be provided to dedicated or general-purpose hardware via the storage medium or from a server via a communication line without using the storage medium. Thereby, the latest functions can be provided at all times through program upgrade.

The log generation device disclosed herein has been primarily described as an in-vehicle electronic control unit mounted on an automobile, but it can be applied to all movable objects such as a motorcycle, a ship, a train, and aircraft. It may also be applied to devices not mounted on a movable body.

What is claimed is:

1. A log generation device comprising
a sensor module, and
a log generation module,
wherein:
the sensor module includes:
an event data generation unit configured to generate event data indicating an event when detecting the event;
a first verification data generation unit configured to generate first verification data for verifying authenticity of the event data; and
a log generation unit configured to generate a security log including the event data and the first verification data;
the log generation module includes:
a log acquisition unit configured to acquire the security log generated by the sensor module;
a second verification data generation unit configured to generate a second verification data using the event data included in the security log; and
a verification unit configured to verify identity of the first verification data and the second verification data; and
the log generation device further comprises a transmission unit configured to transmit the event data when the first verification data and the second verification data are identical.

2. The log generation device according to claim 1, wherein
a first log generation unit, which is the log generation unit, generates a first security log, which is the security log,
the log generation module further includes a second log generation unit configured to generate a second security log including the event data and a third verification data for verifying authenticity of the event data when the first verification data and the second verification data are identical, and
the transmission unit transmits the second security log.

3. The log generation device according to claim 2, wherein
the log generation module further includes a third verification data generation unit configured to generate the third verification data using the event data, the third verification data being different from the first verification data and the second verification data.

4. The log generation device according to claim 2, wherein
the third verification data is either the first verification data or the second verification data.

5. The log generation device according to claim 2, wherein
the log acquisition unit acquires a plurality of first security logs where types of events indicated by the event data are common, and
the second security log includes a specific event data contained in a specific security log, which is an oldest or newest security log among the plurality of first security logs, and the third verification data, which is either the first verification data contained in the specific security log or the second verification data generated using the specific event data.

6. The log generation device according to claim 1, wherein
the security log further includes an importance data indicating importance set according to the event, and
the verification unit verifies the identity when the importance indicated by the importance data is higher than a predetermined importance.

7. The log generation device according to claim 1, further comprising
an importance storage unit configured to store the event and importance set according to the event in association,
wherein
the verification unit verifies the identity when the importance corresponding to the event indicated by the event data included in the security log is higher than a predetermined importance.

8. The log generation device according to claim 1, wherein
the log generation module further includes a load determination unit that determines a processing load of the log generation device, and
a frequency at which the verification unit verifies the identity when the processing load is a first processing load is lower compared to when the processing load is a second processing load, which is lower than the first processing load.

9. The log generation device according to claim 1, wherein
the transmission unit transmits the event data when the first verification data and the second verification data are identical, and also when the event data meets a predetermined condition.

10. The log generation device according to claim 2, wherein
the transmission unit transmits the event data to a log collection device mounted on a movable body together with the log generation device,
the log collection device includes:
a log reception unit configured to receive the second security log from the log generation device;
a fourth verification data generation unit configured to generate a fourth verification data using the event data included in the second security log;
a verification unit configured to verify identity of the third verification data included in the second security log and the fourth verification data; and
an external communication unit configured to transmit an external transmission log, which includes the event data generated based on the second security log, to outside of the movable body when the third verification data and the fourth verification data are identical.

11. A sensor module comprising:
an event data generation unit configured to generate an event data indicating an event when detecting the event;
a first verification data generation unit configured to generate a first verification data for verifying authenticity of the event data; and
a log generation unit configured to generate a security log including the event data and the first verification data.

12. A log generation module mounted on a log generation device together with a sensor module, comprising:
a log acquisition unit configured to acquire a security log generated by the sensor module, which includes an event data indicating an event detected by the sensor module and a first verification data for verifying authenticity of the event data;
a second verification data generation unit configured to generate a second verification data using the event data included in the security log; and
a verification unit configured to verify identity of the first verification data and the second verification data.

13. An electronic control system mounted on a movable body, comprising a log generation device, and a log collection device,
wherein:
the log generation device includes:
a sensor module including:
an event data generation unit configured to generate an event data indicating an event when detecting the event;
a first verification data generation unit configured to generate first verification data for verifying authenticity of the event data; and
a log generation unit configured to generate a security log including the event data and the first verification data;
a log acquisition unit configured to acquire the security log generated by the sensor module;
a second verification data generation unit configured to generate a second verification data using the event data included in the security log;
a verification unit configured to verify identity of the first verification data and the second verification data;
a second log generation unit configured to generate a second security log including the event data and a third verification data for verifying the authenticity of the event data when the first verification data and the second verification data are identical; and
a transmission unit configured to transmit the second security log; the log collection device includes:
a log reception unit configured to receive the second security log from the log generation device;
a fourth verification data generation unit configured to generate a fourth verification data using the event data included in the second security log;
a verification unit configured to verify the identity of the third verification data included in the second security log and the fourth verification data; and
an external communication unit configured to transmit an external transmission log, which includes the event data generated based on the second security log, to outside of the movable body when the third verification data and the fourth verification data are identical.

14. A log generation method executed by a log generation device comprising a sensor module, a log generation module, and a transmission unit, the method comprising:
in the sensor module:
generating an event data indicating an event when detecting the event;
generating a first verification data for verifying authenticity of the event data;
generating a security log including the event data and the first verification data;
in the log generation module:
acquiring the security log generated by the sensor module;
generating a second verification data using the event data included in the security log;
verifying identity of the first verification data and the second verification data; and
in the transmission unit,
transmitting the event data when the first verification data and the second verification data are identical.

15. A log generation method executed by a sensor module mounted on a log generation device, the method comprising:
generating an event data indicating an event when detecting the event;
generating a first verification data for verifying authenticity of the event data;
generating a security log including the event data and the first verification data.

16. A non-transitory computer readable storage medium storing a log generation program executable by a sensor module mounted on a log generation device, comprising instructions that cause the sensor module to:
generate an event data indicating an event when detecting the event;
generate a first verification data for verifying authenticity of the event data; and
generate a security log including the event data and the first verification data.

17. A log generation method executed by a log generation module mounted on a log generation device together with a sensor module, the method comprising:
acquiring a security log generated by the sensor module, which includes an event data indicating an event detected by the sensor module and a first verification data for verifying authenticity of the event data;
generating a second verification data using the event data included in the security log; and
verifying identity of the first verification data and the second verification data.

18. A non-transitory computer readable storage medium storing a log generation program executable by a log generation module mounted on a log generation device together with a sensor module, comprising instructions that cause the log generation module to:
acquire a security log generated by the sensor module, which includes an event data indicating an event detected by the sensor module and a first verification data for verifying authenticity of the event data;
generate a second verification data using the event data included in the security log; and
verify identity of the first verification data and the second verification data.

19. A log collection method executed by an electronic control system mounted on a movable body, comprising a log generation device and a log collection device, the log generation device including a sensor module, a log generation module, and a transmission unit, the method comprising:
in the sensor module:
generating an event data indicating an event when detecting the event;
generating a first verification data for verifying authenticity of the event data; and
generating a security log including the event data and the first verification data;
in the log generation module:
acquiring the security log generated by the sensor module;
generating a second verification data using the event data included in the security log;
verifying identity of the first verification data and the second verification data; and
generating a second security log including the event data and a third verification data for verifying the authenticity of the event data when the first verification data and the second verification data are identical;
in the transmission unit,
transmitting the second security log;
in the log collection device:
receiving the second security log from the log generation device;
generating a fourth verification data using the event data included in the second security log;
verifying identity of the third verification data included in the second security log and the fourth verification data; and
transmitting an external transmission log, which includes the event data generated based on the second security log, to outside of the movable body when the third verification data and the fourth verification data are identical.
